(19) United States
(12) Patent Application Publication
(10) Pub. No.: US 2003/0058062 A1
(43) Pub. Date: Mar. 27, 2003

(54) Filters including a closed-slot resonator

(76) Inventor: Steven K. Remillard, Evanston, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/192,422

(22) Filed: Jul. 10, 2002

Related U.S. Application Data
(63) Continuation-in-part of application No. 09/891,747, filed on Jun. 26, 2001.

(51) Int. Cl. H01P 1/20; H01B 12/02

(52) U.S. Cl. 333/99 S; 333/202; 505/210

(57) ABSTRACT

A resonator is provided comprising a conductive element, and a closed-slot in the conductive element, where the length of the closed slot dictates the resonating properties of the resonator. The closed slot generally confines the electromagnetic field resonated by the resonator in a direction perpendicular to a plane of the resonator, providing greater flexibility in the placement of the closed-slot resonator within the filter housing. Further, where three-dimensional resonators are used, compact resonator configuration such as spiral resonator configurations may be securely mounted within the filter without incurring severe filter losses due to the mounting mechanism, allowing filters designed with closed-slot resonators to be more compact in size than filters designed with prior art three-dimensional resonator configurations.

### CROSS-REFERENCE TO RELATED APPLICATIONS

This application is a continuation-in-part of U.S. patent application Ser. No. 09/891,747, filed Jun. 26, 2001, entitled “Closed-Slot Resonator,” the disclosure of which is hereby expressly incorporated herein by reference. Additionally, this application claims the benefit of U.S. patent application Ser. No. 10/027,078, filed Dec. 20, 2001, entitled “Low Loss Tuners,” the disclosure of which is hereby expressly incorporated herein by reference.

### TECHNICAL FIELD

This disclosure relates generally to filters including resonators, and more particularly, to filters including electromagnetic resonators having a closed-slot configuration.

### BACKGROUND

Conventional resonant cavity filters consist of an outer housing made of an electrically conductive material. One or more resonant elements are mounted inside the housing, generally by use of a dielectric material. Electromagnetic energy is coupled through a first coupling mechanism in the housing to a first resonator, to any additional resonators in the housing, and then exits the housing through a second coupling mechanism.

Resonators are often used in filters to pass or reject certain signal frequencies. The particular design, shape, materials and spacing of the housing, resonant elements, and apertures between resonant elements will determine the signal frequencies passed through the filter, as well as the insertion loss of the filter and quality factor (“Q”) of each resonator. To optimize filter performance, the resonators should have a minimum of signal loss in the passed frequency range.

Resonators generally consist of a length of conductive material, and are typically of either a two-dimensional type, or a three-dimensional type. The two-dimensional resonators are formed by depositing a conductive layer (for example, a thin film high temperature superconductive (HTS) material) onto a substrate, where some of the HTS material is removed from the substrate leaving a length of conductive material behind. The length of conductive material forms one or more resonators. The three-dimensional resonators are formed by shaping a length of conductive element to a desired shape, or cutting a resonator of a specific length and shape from a piece of conductive material. Alternatively, the three-dimensional resonators may be formed from a substrate prepared in a desired length and shape, and coating the substrate with a conductive material (for example, a thick film of HTS material). Typically, a greater amount of electromagnetic coupling may be achieved between adjacently-mounted, three-dimensional resonators than between two-dimensional resonators.

One source of signal loss in the passed frequency range is due to the design of a resonator. The geometry of the conductive material forming the resonator dictates the resonating properties of the resonator, thereby controlling the properties (e.g., loss, frequency, etc. . . . ) of the filter in which the resonator is disposed. The conductive material of the resonator may be straight, or curved in the form of, for example, an “M” configuration or a spiral configuration. Curving the conductive material reduces the space required for the resonator, and thus the filter, generally with minimal effect to the resonator filtering characteristics. However, the electromagnetic fields resonating around the conductive material of the resonator are not confined to the resonator, but rather suffer from a contact with the filter housing or other components that may be in the resonant cavity. Some of the loss is due to the resonance of the electromagnetic field in a direction parallel to a plane of the resonator, discussed below, and results in signal loss as the electromagnetic wave propagates through the filter. In addition, implementing certain resonator shapes as three-dimensional resonators is difficult, because securely mounting such shapes is accomplished at the cost of severe filter losses, as discussed below. A prior art split-ring resonator 50 and a prior art spiral resonator 60 are shown in FIGS. 1 and 2, respectively.

Referring to FIG. 1, the split-ring resonator 50 includes a conductive element 52, and an open slot shown generally at 54. The split-ring resonator 50 may be mounted in a filter using, for example, a mounting post 56 and mounting ring 57 connected to the conductive element 52. The length of the conductive element 52 controls the resonating properties of the split-ring resonator 50. However, the electromagnetic fields resonating around the split-ring resonator 50 are not confined to a plane perpendicular to the resonator 50, but rather propagate in a plane parallel to the split-ring resonator 50, as shown by arrow 58. The propagation of the electromagnetic fields in a plane parallel to the resonator 50 results in a contact of the electromagnetic field propagating around the resonator with a housing of the filter in which the resonator is disposed, translating to a signal loss of the filter.

Referring to FIG. 2, the prior art spiral resonator 60 includes a conductive element 62, and an open slot shown generally at 64. The use of the spiral conductive element 62 is advantageous because the spiral resonator 60 may be formed smaller than other prior art resonators, for example the split ring resonator 50, for a given frequency. The electromagnetic field resonating around the resonator 60 is not confined around the resonator, but rather is propagated in a direction parallel to the resonator 60, generally indicated by an arrow 66. This propagation of the electromagnetic field in the direction parallel to the resonator 60 causes the electromagnetic field to contact the filter housing, resulting in severe, filter losses. Further, where the spiral resonator is a three-dimensional spiral resonator, a practical way of securely mounting the spiral resonator 60 in a filter is not known without incurring excessive electromagnetic losses and a low Q factor for the filter. A mounting ring as discussed above with respect to the split-ring resonator 50 does not provide a secure mount for the spiral resonator 60. Where the spiral resonator 60 is affixed to a glass plate which is further mounted within the filter, electromagnetic energy is absorbed by the glass plate, resulting in severe filter losses and a low Q value for the resonator. Further, an extension of the conductive element 62 forming a tab (not shown) is not practical as the tab further increases the contact of the electromagnetic field propagating around the resonator with the filter housing, resulting in severe filter losses. Where a tab is used and the filter is an HTS filter, the tab is coated with an HTS material. However, the HTS material is brittle, and easily cracked when mounted in the filter, which in turn increases contact of the electromagnetic field propagating around the resonator with the filter housing, resulting in severe losses of the filter. Where the filter is an HTS filter, and the tab is left uncoated with the HTS material, contact of the electromagnetic fields propagating around the resonator with the filter housing and corresponding filter losses are increased.

Another way to reduce contact of the electromagnetic field propagating around the resonator with the filter housing, and thus the signal loss of the filter, is to mount the resonator in the center of a large filter cavity, far from the filter housing. However, spacial constraints dictate that the filters remain small in size, prohibiting the use of large filter housings. Further, where the filter utilizes superconductive materials to reduce signal losses from the filter, operating costs associated with the super-cooling systems required to implement superconductivity necessitate using smaller filters.

### SUMMARY

In one embodiment, a filter is provided that may include a housing having a cavity therein, and a resonator located in the cavity of the housing, the resonator having a conductive element and a closed slot in the conductive element. The filter may further include an input coupling mechanism in the housing for coupling electromagnetic energy through the housing to the resonator. The filter may also include a mounting post for mounting the resonator to the housing, where the mounting post may be formed from a dielectric material or a conductive material.

The filter may further include a plurality of housing cells, where each cell may contain a resonator, and coupling mechanisms for coupling electromagnetic energy from each resonator to an adjacent resonator. The coupling mechanisms may comprise conductive plates having apertures therein. The apertures may be positive apertures or negative apertures. The positive apertures may comprise a U-shaped opening along the perimeter of the conductive plate. The negative apertures may comprise an opening in the conductive plate including a conductive element mounted therein. Where the opening in the conductive plate is a first opening, the negative aperture may include further openings proximate to the first opening. In addition, the filter may be placed in a super-cooling fluid, or coupled to a cryogenic refrigerator cooling element.

Further, the filter may include an adjustable tuning element mounted adjacent the resonator for tuning the filter.

### BRIEF DESCRIPTION OF THE DRAWINGS

FIG. 1 illustrates a split-ring resonator in accordance with the prior art;

FIG. 2 illustrates a spiral resonator in accordance with the prior art;

FIG. 3A is a perspective view of a resonator;

FIG. 3B is a perspective view of the resonator of FIG. 3A with a superconductive coating;

FIG. 3C is a cross-sectional view along line A-A of the resonator of FIG. 3B;

FIG. 4 illustrates an isometric view of a filter utilizing the resonator of FIGS. 3A-3C;

FIG. 5 illustrates a top view, partially broken away, of the filter of FIG. 4;

FIG. 6 illustrates a side view of the filter of FIG. 4 with a cover of the filter removed;

FIG. 7 illustrates a cross-sectional view taken along the line A-A of FIG. 6, showing the negative cross-coupling mechanism;

FIG. 8A illustrates a cross-sectional view taken along the line B-B of FIG. 5, showing the positive aperture;

FIG. 8B illustrates a cross-sectional view taken along the line C-C of FIG. 6, showing the negative aperture;

FIG. 9 illustrates a partial exploded view of the filter of FIG. 4 showing the resonator mounting post;

FIG. 10 illustrates an exploded view of a resonator mounted in a cavity of the filter of FIG. 4;

FIG. 11 illustrates a rear view of the filter of FIG. 4 with the rear housing wall removed;

FIG. 12 illustrates a bottom partial sectional view of the filter of FIG. 4;

FIG. 13 illustrates an enlarged view of a portion 13 of FIG. 12;

FIG. 14 illustrates an exploded view of the filter of FIG. 4;

FIG. 15 illustrates a slot-line resonator; and

FIG. 16 illustrates a meander line closed-slot resonator.

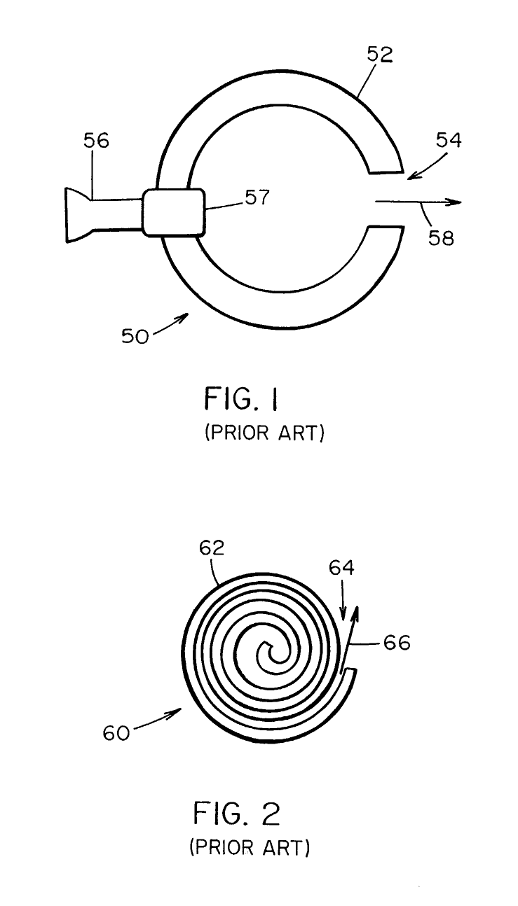

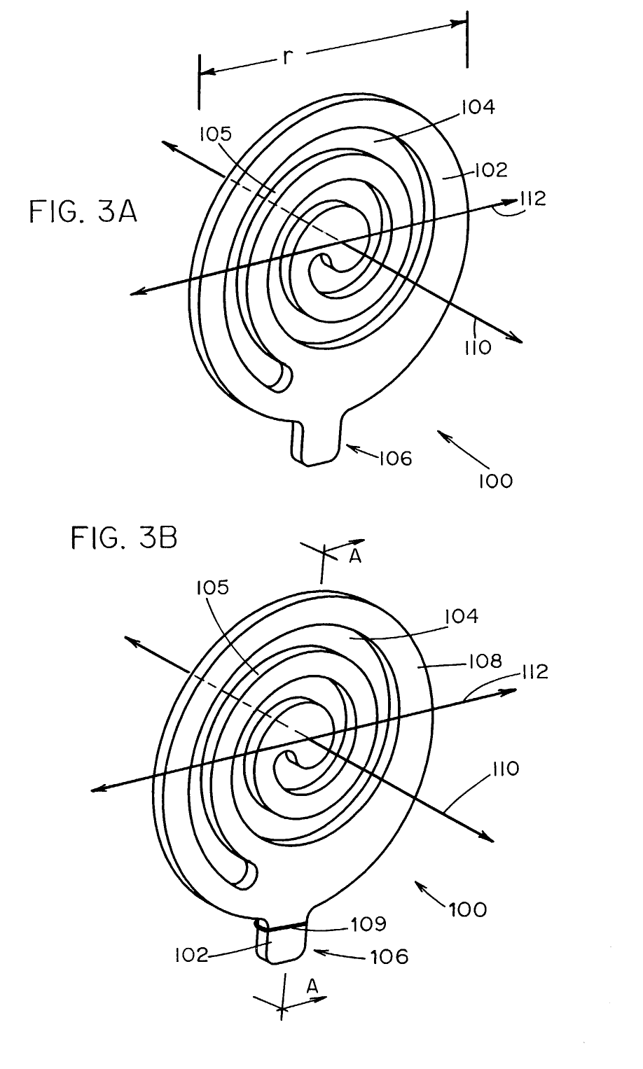

### DETAILED DESCRIPTION

As disclosed herein, a filter includes a resonator having a conductive element and a closed slot in the conductive element. The closed slot in the conductive element dictates the resonance properties of the resonator, and generally confines the electromagnetic field resonated around the resonator to a direction perpendicular to a plane of the resonator. Because the electromagnetic field is confined to a direction perpendicular to a plane of the resonator, dissipation of electromagnetic energy in filter housing walls is minimized, improving the filter efficiency, and providing greater flexibility as to placement of the closed-slot resonator within a filter. In addition, confinement of the electromagnetic field around the resonator to a direction perpendicular to a plane of the closed-slot resonator allows a mounting tab to be formed with the conductive element of the resonator without incurring severe losses due to contact of the electromagnetic field propagating around the resonator with the filter housing. Further, the confinement of the electromagnetic field around the resonator allows the mounting post for mounting the resonator in the filter to be formed from any material without affecting the coupling of electromagnetic fields between the resonator, and for example a housing of the filter in which the resonator is disposed.

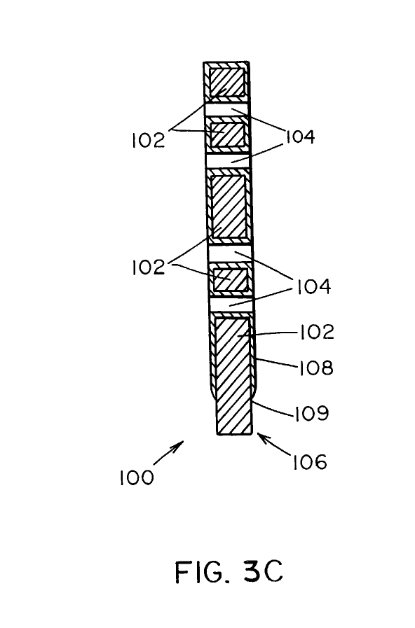

FIG. 3A illustrates a closed-slot resonator, generally shown at 100. The resonator 100 includes a conductive element 102 and a closed slot 104 completely penetrating the conductive element 102. The slot 104 is a closed slot because an edge 105 of the slot 104 is completely enclosed by the conductive element 102. The resonator 100 may further include a tab 106 formed with the conductive element 102, for mounting the resonator 100 in, for example, a cavity of a filter housing as discussed below.

Unlike resonators of the prior art, where the length of the conductive material dictates the resonating properties of the resonator, the length of the closed slot 104 dictates the resonating properties of the resonator 100. For example, the length of the slot 104 may be approximately one-half the wavelength of the desired center frequency for which the filter is designed to pass. Alternatively, the slot 104 may be any length sufficient for passing the desired frequency for which the filter is designed, as would be appreciated by one skilled in the art.

Utilizing the resonator 100 where the length of the slot 104 dictates the resonating properties generally confines the electromagnetic field resonated around the resonator to a plane perpendicular to the resonator 100, indicated by an arrow 110, and virtually eliminates electromagnetic field resonance outside the slot 104 in a direction parallel to a plane of the resonator 100, indicated by an arrow 112. Confining resonance in a direction perpendicular to the plane of the resonator 100 reduces contact of the electromagnetic field with, for example, a filter housing in which the resonator is mounted. Thus, filter losses are reduced, and greater flexibility is provided for placement of the resonator within the filter housing and for the materials used to mount the resonator to the filter housing, as discussed below.

Further, where a three-dimensional closed-slot resonator 100 is formed, a mounting tab, for example the mounting tab 106, may be used to securely mount the resonator within a filter, without incurring the severe losses suffered by prior art resonators using such tabs, as discussed below. Thus, the filters made with three-dimensional resonators may utilize, for example spiral-shaped resonators, and therefore be more compact in size for a given frequency than filters designed with prior art three-dimensional resonators. Because the closed slot 104 and not the conductor 102 dictates the resonance properties of the resonator, the tab 106 does not cause the electromagnetic field around the resonator to contact the filter housing. Further, the tab 106 as well as other mounting hardware for mounting the resonator may be formed from any material, i.e., a conductor or an insulator, and the mounting hardware may be relatively short, without fear of generating losses associated with the contact of the electromagnetic field propagating around the resonator with the filter housing.

In one embodiment where it is desired to filter an electromagnetic signal to pass a center frequency (f_{c}) of 1.9 GHz, the closed-slot resonator 100 would be designed with a radius “r” of 0.8 inches, where the closed slot 104 is approximately ½ wave length of f_{c}.

FIG. 3B illustrates an alternative embodiment, wherein the resonator 100 is coated with a superconductive coating for use in an HTS filter. FIG. 3C is a cross sectional view of the resonator of FIG. 3B along line A-A. Elements of FIGS. 3B and 3C having the same reference numerals as elements of FIG. 3A are the same and will not be discussed in detail. HTS filters utilize materials which are superconductive above liquid nitrogen temperatures. In this embodiment, the resonator is a three-dimensional resonator, and the material 102 need not be conductive, but rather is a substrate (conductive or non-conductive) which is coated with a conductive material to form the resonator 100. The material 102, the substrate in this embodiment, may be a flat yttria stabilized zirconia disk or sheet which is coated with an ink or powder for creating a “thick film” superconductive coating 108, for example, as described in U.S. patent application Ser. No. 09/799,782, “Raw YBCO Precurser Dip Coating Ink,” hereby incorporated by reference. The superconductive coating 108 does not coat the entire substrate 102, but rather the tab 106 is not coated, as indicated by superconductive coating termination 109, further discussed below. The ink or powder is fired to produce a film. The film is furnace reacted according to known methods of reacting the superconducting material, for example, the process of peritectic recrystalization. One skilled in the art will appreciate that the resonator 100 may be a two-dimensional resonator where “thin film” or epitaxial processes for creating superconductive elements may also be used, where a film of the material is placed on a flat substrate.

One significant advantage of this embodiment is that the tab 106 may be used to securely mount the resonators within the filter without incurring severe losses in the filter. As discussed above, using tabs formed with the conductive element cause the electromagnetic field propagated around the resonator to contact the filter housing, resulting in severe losses in the filter. The losses could be slightly reduced by coating the tab with HTS material, however, coating the tab has drawbacks. Because the HTS material is generally brittle, mounting a tab coated with the HTS material within a mounting post typically damages the HTS coating, virtually eliminating any advantages obtained from the HTS coating on the tab. Further, it is necessary that the mounting post for resonators of the prior art be formed of a nonconductive material to electrically isolate the resonator from the filter housing to minimize contact of the electromagnetic field around the resonator with the housing and the losses resulting therefrom.

The disclosed device solves these problems because the electromagnetic fields, being contained around the closed-slot resonator 100, are very weak in the area of the tab 106. The tab can be left uncoated with HTS material for mechanical strength, without generating significant losses at the coating termination area 109. In addition, a mounting mechanism can be relatively short, and even formed from an electrical conductor, without fear of generating losses due to currents flowing on the cavity walls proximate the tab.

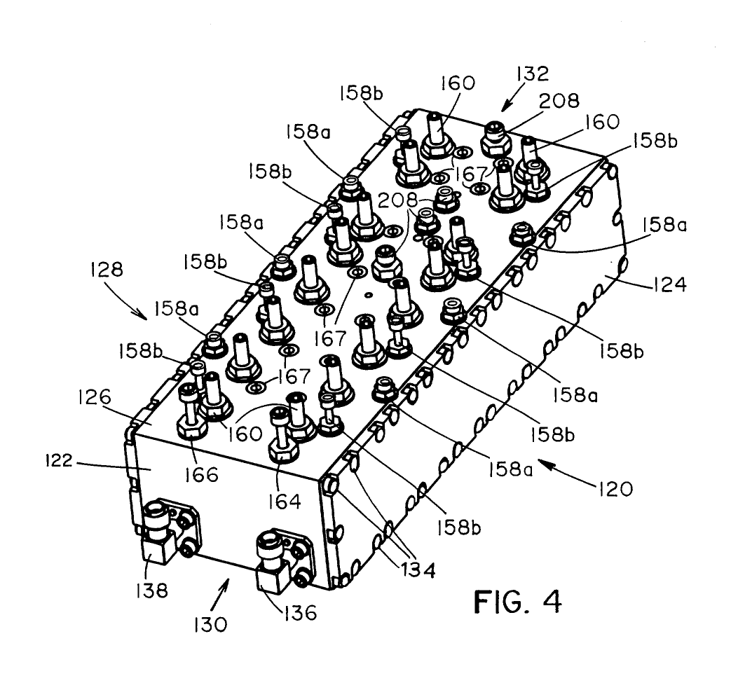

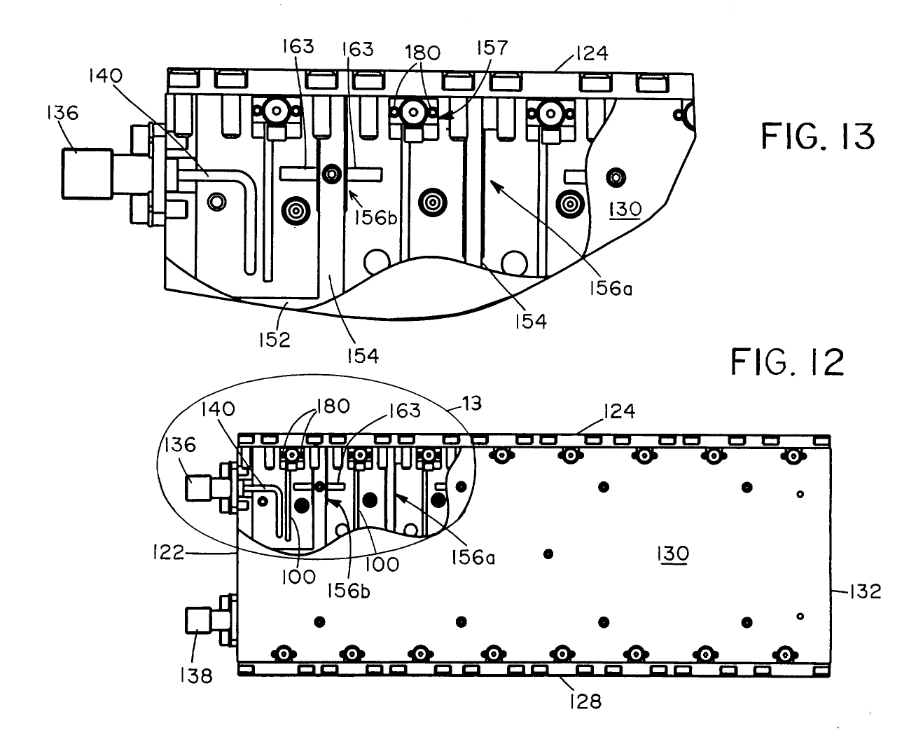

FIGS. 4-14 illustrate various views of a filter 120 utilizing the closed-slot resonator 100. Referring to FIGS. 4-8, the filter 120 includes a housing having a front wall 122, a right side wall 124, a top wall 126, a left side wall 128, a bottom wall 130, and a rear wall 132. The housing may be made of any suitable strong material, but a metal such as copper, silver or aluminum is preferred. The housing is attached together with bolts 134. The front wall 122 includes an input coupling mechanism 136 and an output coupling mechanism 138 for coupling electromagnetic signals to and from the filter 120, respectively. The input and output coupling mechanisms 136 and 138 may be of a variety of constructions, including an input coupling loop 140, or a probe (not depicted) extending into the filter.

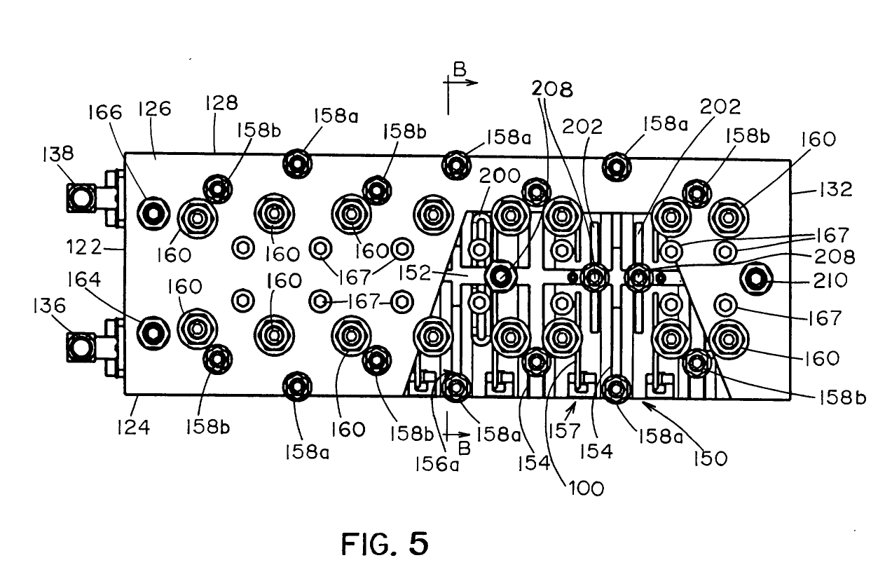

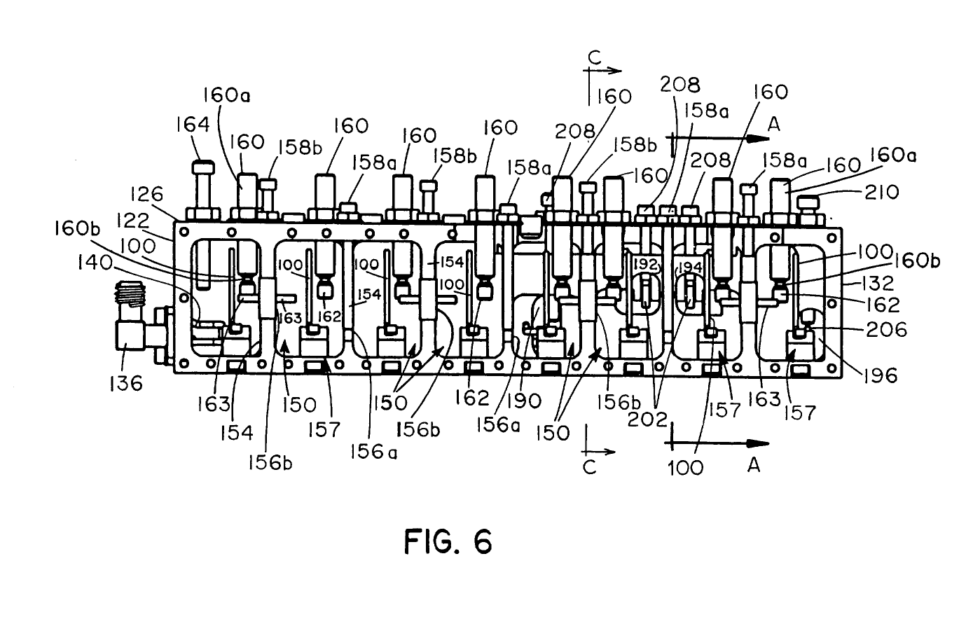

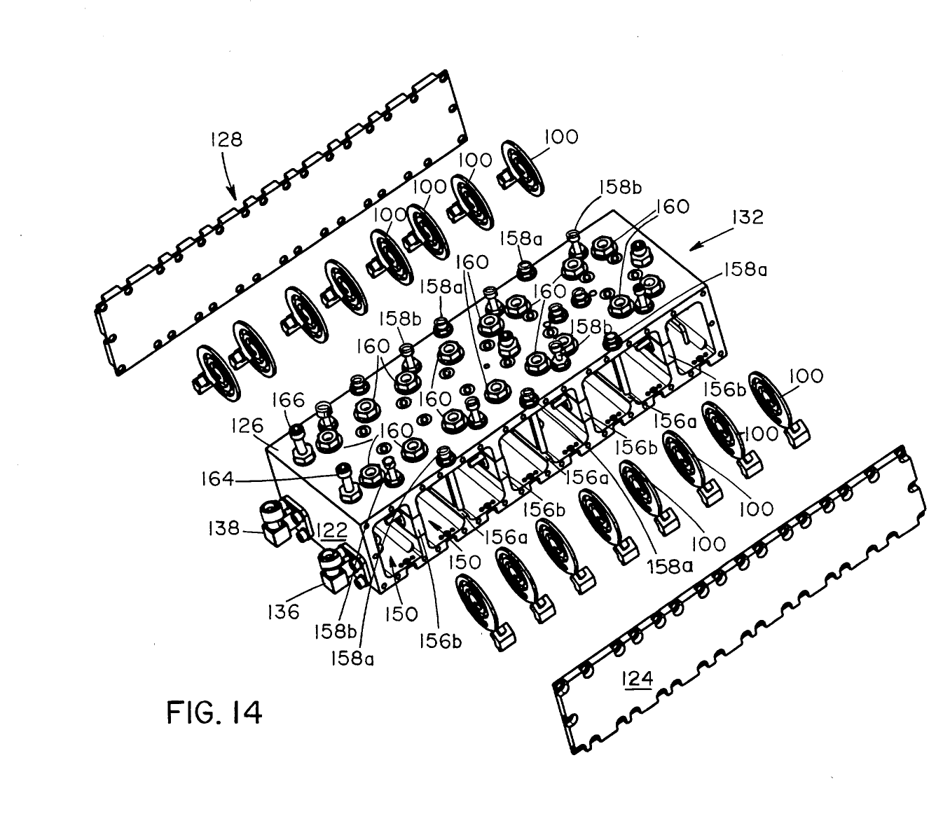

As best seen in FIGS. 5, 6, 9 and 10, a plurality of cavities, generally depicted at 150, are located within the housing of the filter 120 and defined by the filter housing and by a central wall 152 and cell walls 154. The cell walls 154 do not completely enclose the cavities 150 from each other, but instead define positive apertures 156a, and negative apertures 156b, where each cell 150 includes the closed-slot resonator 100 mounted to the housing of the filter 120 by, for example, a mounting post 157. The apertures 156 may be “tuned,” for example, by positive aperture tuners 158a and negative aperture tuners 158b (FIGS. 4-8), where turning the aperture tuners 158a and 158b raises or lowers the tuner as would be appreciated by one skilled in the art. The size and shape of the positive and negative apertures 156a and 156b adjusts the electromagnetic coupling between resonators 100 in adjacent cells 150. The positive and negative apertures 156a and 156b are alternately utilized between the cells of the resonator, best seen in FIGS. 6 and 14. The positive and negative apertures 156a and 156b are shown in more detail in the sectional drawings of FIGS. 8a and 8b.

FIG. 8a illustrates the positive aperture 156a. As can be seen, the positive aperture 156a is generally U-shaped. In the illustrated embodiment, a base “b” and the legs “L” measure approximately 0.9 inches, where the width of the legs “w1” measure approximately 0.06 inches, and are spaced approximately 0.05 inches from the top and bottom 126 and 130 of the housing, respectively. The negative apertures 156b are shown in more detail in the sectional drawing of FIG. 8b.

As shown in FIG. 8b, the negative aperture 156b includes a circular opening 159 which may be filled, for example, by a nonconductive material such as plastic. At approximately the center of the circular opening 159 is a second opening 161, through which a conductive element 163, for example a length of wire, is mounted. The negative aperture 156b further includes a plurality of holes 165 through the plastic of the opening 159 proximate the second opening 161. In the illustrated embodiment, the circular opening 159 is approximately 0.3 inches in diameter, where the second opening 161 is approximately 0.06 inches. The conductive element 163 is approximately 0.06 inches in diameter and approximately 0.5 inches in length. The plurality of holes 165 through the plastic are each approximately 0.06 inches in diameter.

Alternating positive apertures 156a and negative apertures 156b through the filter produces negative cross-coupling between non-adjacent resonators 100 within the filter. The plurality of holes 165 increase coupling between resonators adjacent each negative aperture 156b, where the conductive element 163 serves as an antenna improving coupling between the neighboring resonators. In this embodiment, where the filter 120 is designed to pass the center frequency of approximately 1.9 GHz, approximately 20 MHz band width is achieved by the filter. In an alternate embodiment (not shown), the conductive element 163 is not provided within the second opening 161. In this alternate embodiment, where the filter 120 is designed to pass the center frequency of 1.9 GHz, the filter 120 is capable of achieving approximately 5 MHz of band width.

As best seen in FIGS. 4 and 5, the filter 120 may further include frequency tuners 160 and measurement openings 167 extending through the top wall 126 of the housing adjacent to resonators 100. The frequency tuners 160 may each include an adjustment element 160a, an electrical insulator 160b and a conductive frequency tuning portion 162 (FIG. 6). In operation, when the tuning portion 162 perturbs the fields of the resonator 100, the capacitance of the resonator 100 is adjusted, as would be appreciated by one having ordinary skill in the art. The currents induced on the tuning portion 162 are not shorted to the housing walls, owing to the insulator 160b disposed between the adjustment element 160a and the tuning portion 162. Accordingly, the attendant heating and Q degradation associated with shunting induced tuner currents to ground is avoided.

The adjustment element 160a may be fabricated from conductive material, for example, brass, stainless steel, or any other suitable material, including nonconductive materials. The insulator 160b may be fabricated from non-conductive material, for example, a plastic or any suitable dielectric such as Ultem 1000, which is commercially available from General Electric Corporation. Alternatively, the insulator 160b may be fabricated from any other suitable plastic, resin, ceramic or any other non-conducting material.

The tuning portion 162 may be a superconducting or non-superconducting material that may be metallic or otherwise conductive. In particular, the tuning portion 162 may be fabricated from, for example, copper or silver plated aluminum. While the tuning portion 162 is shown as cylindrical in the drawings, those having ordinary skill in the relevant art will readily appreciate that the tuning portion 162 could have any other suitable shape than cylindrical and, therefore, the cylindrical shape of the tuning portion 162 is merely exemplary. Further details about the frequency tuner 160 may be found in a pending application entitled “Low Loss Tuners,” which is assigned to the assignee of the present patent, bears U.S. Ser. No. 10/027,078, was filed on Dec. 20, 2001, and which has been incorporated herein by reference herein.

The measurement openings 167 are provided for taking measurements, for example electromagnetic field strength, frequency readings, etc. . . . at various locations in the filter 120.

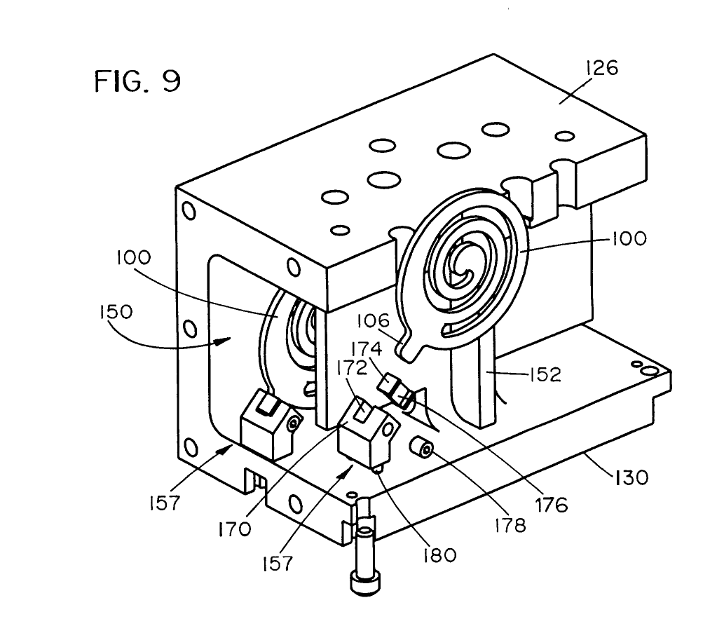

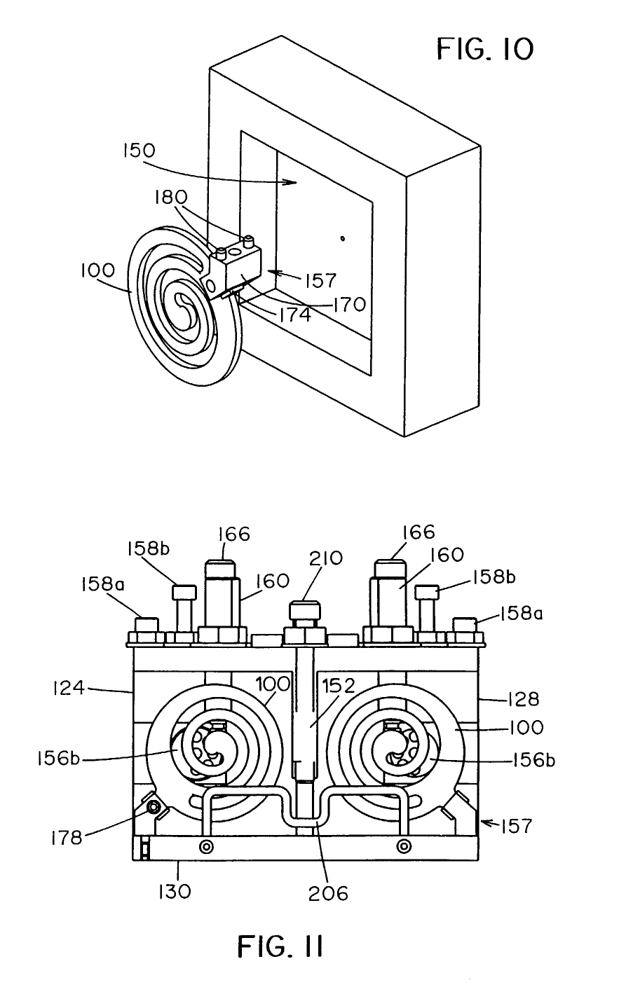

As best seen in FIGS. 9 and 10, the resonator 100 is mounted within the cell 150 by the mounting post 157. The mounting post 157 includes a mounting base 170 having a mounting base groove 172 sized for receiving an I-shaped spacer 174. The I-shaped spacer 174 includes a spacer groove 176 sized for receiving the tab 106 of the resonator 100. The tab 106 of the resonator 100 is placed within the spacer groove 176, which is further placed within the mounting base groove 172 of the mounting base 170, and is secured by a set screw 178. The mounting post is secured to the filter housing by, for example, mounting screws 180. The mounting post 157 is typically constructed of a dielectric material. However, because the electromagnetic field propagated by the closed-slot resonator 100 is confined to a direction perpendicular to the plane of the resonator, the mounting post 157 may be formed from any material without affecting contact of the electromagnetic signal around the resonator with the filter housing. In a further embodiment not shown, the I-shaped spacer 174 is not required. In this embodiment, the resonator 100 may be mounted directly within the mounting base groove 172, where the resonator 100 is directly fastened within the mounting post 157 using the set screw 178.

The filter 120 further includes an input tuner 164 and an output tuner 166 (FIGS. 4, 5), where rotation of the input and output tuners 164 and 166 adjusts capacitance of the input and output coupling mechanisms 136 and 138 respectively, thereby providing impedance matching capabilities for the filter 120.

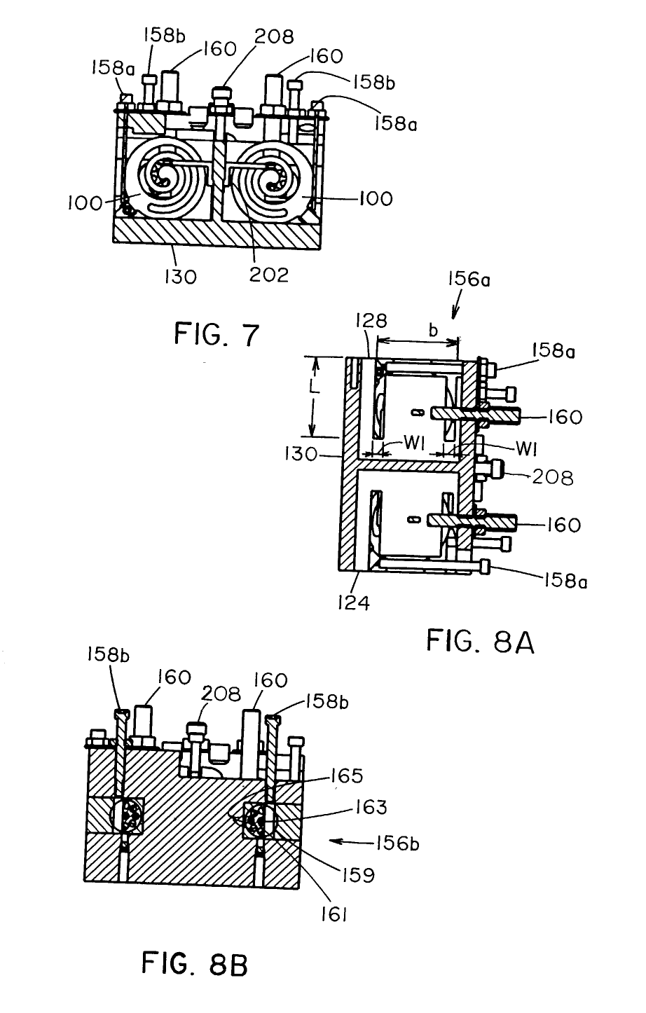

As best seen in FIG. 6, the central wall 152 further includes apertures, for example, the first aperture 190, a second aperture 192, a third aperture 194, and a fourth aperture 196. The apertures provide portals by which various coupling mechanisms may couple electromagnetic signals between cavities located adjacent the right side wall 124 of the filter, and cavities adjacent to the left side wall 128 of the filter. The various coupling mechanisms may include a positive cross-coupling mechanism 200 (FIG. 5) extending through the first aperture 190 of the central wall 152, negative cross-coupling mechanisms 202 (FIGS. 5, 7) extending through, for example, the second and third apertures 192 and 194, and a U-turn coupling mechanism 206 (FIG. 11) extending through the fourth aperture 196. Elliptical coupling mechanism tuners 208 (FIGS. 4, 5) are provided for adjusting the tuning of the positive and negative cross-coupling mechanisms 200 and 202 as would be appreciated by one skilled in the art. U-turn coupling mechanism tuner 210 is provided to adjust the tuning of the U-turn coupling mechanism 206, as would be appreciated by one skilled in the art.

In operation, upon assembly of the filter 120, an electromagnetic signal is transmitted through the input coupling mechanism 136 to the input coupling mechanism loop 140. The electromagnetic signal propagates through the resonators 100, the cell walls 154 and positive and negative apertures 156a and 156b, with cross-coupling provided by the positive cross-coupling mechanism, the negative cross coupling mechanism, and the U-coupling mechanisms 200, 202, and 206 as would be appreciated by one skilled in the art. After propagating through the filter 120, the electromagnetic signal is coupled through the output coupling mechanism 138, having been filtered to a desired pass frequency for which the filter was designed. The positive and negative aperture tuners 158a and 158b, the frequency tuners 160, elliptical coupling mechanism tuners 208, and u-turn coupling mechanism tuner 210 are used to tune the filter 120 to achieve desired filtering characteristics, as is well known in the art. Filter measurements may be taken using measurement openings 167. If the closed-slot resonators 100 include superconducting material, the filter 120 is placed in a cryocooler (not depicted) such as the K535 Cryo cooler manufactured by RICOR Cryogenic and Vacuum Systems of Israel, or immersed in a super-cooling fluid such as liquid nitrogen. The filter 120 is designed to be easily sealed so that no super-cooling fluid, such as liquid nitrogen enters the interior of the filter while still permitting the filter to be opened for service.

Using the closed-slot resonator 100 in the filter 120, where the electromagnetic fields are generally confined to a direction perpendicular to a plane of the resonator 100, virtually eliminates filter losses due to contact of the electromagnetic field propagating around the resonator with the housing of the filter. Further, because the electromagnetic field resonated by the resonator is generally confined to a direction perpendicular to the plane of the resonator 100, a greater flexibility in resonator placement is achieved. For example, because of the virtual elimination of the contact of the electromagnetic field with the housing, the closed-slot resonator 100 may be placed in smaller sized cavities than open-slot resonators of the prior art, and mounting hardware may be shorter than that of the prior art, without suffering from loss with the filter housing. In this way, filters of smaller size may be designed as compared with filters utilizing prior art resonators without a closed slot. Additionally, where three-dimensional resonators are used, resonator shapes of smaller size may be used, for example a spiral-shaped resonator, without incurring the severe filter losses associated with mounting such resonator shapes within the filter. Thus, resonators of a more compact size for a given frequency may be designed than with open-slot resonators of the prior art, providing advantages where spacial constraints exist. Further, for the superconductive coated resonators used in the HTS filter, a tab may be used to mount the resonator, and the tab and mounting hardware may be formed from any material, conductive or an insulator. Further, the tab need not be coated with superconductive material, thereby increasing the mechanical strength of the tab without incurring significant electromagnetic losses at the coating termination area.

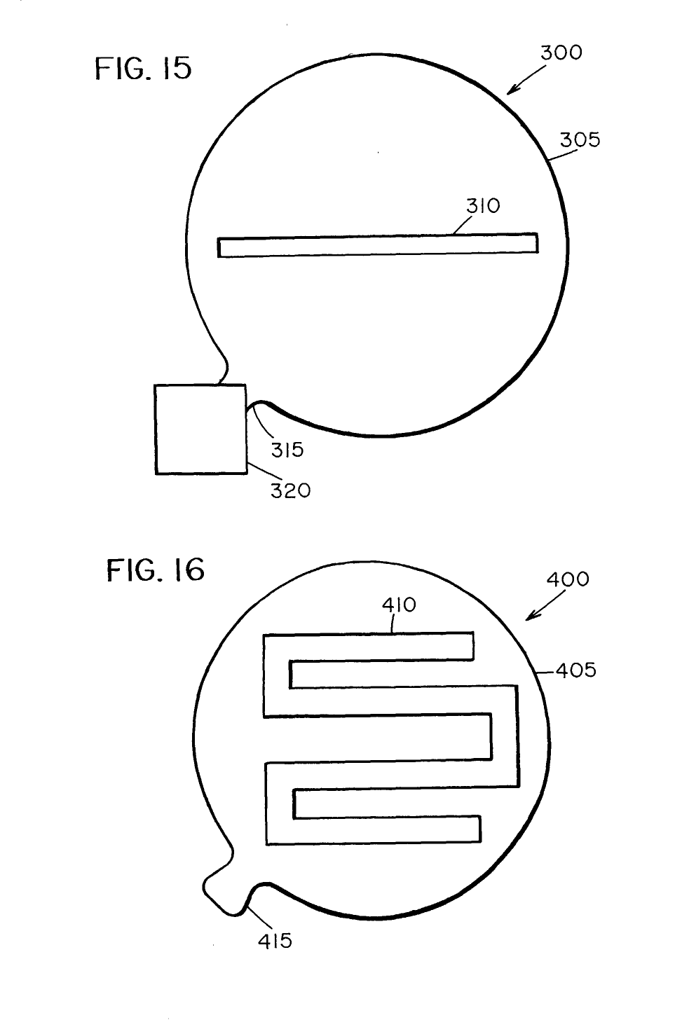

FIG. 15 illustrates a closed-slot resonator 300 utilizing a straight line slot. In this embodiment, the closed-slot resonator 300 includes circular conductive element 305 with a straight line slot 310 completely penetrating the circular conductive element 305. The straight line closed-slot resonator 300 further includes a mounting tab 315 for mounting the closed-slot resonator 300 within a filter using, for example a mounting post 320. The conductive element 305 may be, for example, circular with a 0.8 inch diameter, where the straight line slot 310 is approximately 0.65 inches in length for use in a filter capable of filtering a frequency of 9 GHz. In this embodiment, the length of the slot 310 is approximately ½ wave length of the frequency for which the filter is designed to pass.

FIG. 16 illustrates a closed-slot resonator 400 having a conductive element 405 and an “M”-shaped (meander line) closed slot 410 completely penetrating the circular conductive element 405. The closed-slot resonator 400 further includes a mounting tab 415 allowing the closed-slot resonator 400 to be mounted within a filter. In accordance with this embodiment, the closed-slot resonator 400 may be designed for passing, for example a 3 GHz frequency, where the meander line closed slot 410 is approximately 1.97 inches in length, and is approximately ½ wave length of the passed frequency. In this embodiment, the conductive element 405 is approximately 0.8 inches in diameter.

Similar to as discussed above with the closed-slot resonator 100, the closed slot of the resonators 300 and 400 dictate the resonating properties of the resonator. The closed-slot resonators 300 and 400 may be implemented as two-dimensional resonators or three-dimensional resonators, and provide similar advantages as discussed above with respect to the resonator 100.

The closed-slot resonators 100, 300 or 400 may be used in cavity filters for filtering received and transmitted signals in, for example, a cellular base station. When utilized with filters for filtering received signals, the reduced contact of the electromagnetic field propagating around the resonator with the filter housing provides greater sensitivity for the filter. When used for filtering transmitted signals, the reduced contact of the electromagnetic field with the filter housing results in less heat produced by the filter, translating to lower operating costs, especially where the filter is an HTS filter. Further, although the closed-slot resonator has been described herein as utilizing three-dimensional resonators, one skilled in the art would realize that closed-slots could be implemented in two-dimensional resonators, while still realizing the advantages discussed above.

Although an embodiment disclosing a 16-pole filter is discussed, one skilled in the art would realize that the closed-slot resonator 100 may be utilized with a filter having any number of poles while achieving the disclosed advantages. The filter characteristics of the disclosed filter can be designed by procedures well known to those skilled in the art. Briefly, the designer selects the desired filter response and filter type, and then determines the required number of resonators with the aid of known nomographs. Using known tables for the normalized conventional parameter k, the required values of quality factor Q and coupling coefficient K can be determined. Using a known de-tuning and adjusting procedure, the filter is set to the desired K from data listing the K as a function of aperture or negative coupler dimension. An adjusting screw in the aperture is used to fine tune the value of K to that specified by design. The length of the closed slot for the resonator may be calculated by known methods in a similar fashion as the length of the conductive element was calculated in resonators of the prior art.

Because the electromagnetic field resonated around the closed-slot resonators 100, 300 and 400 is generally directed in a direction perpendicular to a plane of the resonators, contact of the electromagnetic field propagating around the resonator with the filter housing is virtually eliminated, thereby improving the efficiency of the filters designed with such resonators. Additionally, greater flexibility as to the placement of the closed-slot resonators 100, 300 and 400 within the filter is provided, for example, allowing the resonators to be placed into smaller filter cavities without concerns of electromagnetic field contact with the filter housing, thereby allowing filters of smaller size to be designed. Further, the mounting post for the closed-slot resonators may be formed from any material without affecting the contact of electromagnetic fields with the filter housing. Additionally, because the length of the closed slot 104 dictates the resonating properties of the closed-slot resonators, they may be securely mounted within the filter using for example, mounting tabs without incurring the severe filter losses associated with contact of the electromagnetic fields around the resonator with the filter housing. Further, where the closed-slot resonator is coated with a superconductive material for use in an HTS filter, the tab of the resonator need not be coated with the superconductive coating, increasing the mechanical strength of the tab, without incurring severe losses at the coating termination area.

The foregoing detailed description has been given for clearness of understanding only, and no unnecessary limitations should be understood therefrom, as modifications would be obvious to those skilled in the art.

We claim:

1. A filter comprising:
a housing having a cavity therein;
a resonator located in the cavity of the housing, the resonator having a conductive element and a closed slot in the conductive element; and
an input coupling mechanism in the housing for coupling electromagnetic energy through the housing to the resonator.

2. The filter of claim 1 further comprising a mounting post for mounting the resonator to the housing.

3. The filter of claim 2 wherein the mounting post is formed from a dielectric material.

4. The filter of claim 2 wherein the mounting post is formed from conductive material.

5. The filter of claim 1 wherein the conductive element comprises a high-temperature superconductor.

6. The filter of claim 1 wherein the slot has a spiral shape.

7. The filter of claim 1 wherein the conductive element is generally disc shaped.

8. The filter of claim 1 wherein the resonator further comprises a tab formed with the conductive element for holding the resonator.

9. The filter of claim 8 wherein the tab comprises a high-temperature superconductor.

10. The filter of claim 9 wherein the high-temperature superconductor is a layer on a substrate.

11. The filter of claim 8 wherein the tab is a conductive element.

12. The filter of claim 1 further comprising:
a plurality of housing cells, each cell containing a resonator; and
at least one coupling mechanism for coupling electromagnetic energy from each resonator to an adjacent resonator.

13. The filter of claim 12 wherein the at least one coupling mechanism comprises a conductive plate having an aperture therein.

14. The filter of claim 13 wherein the aperture is a positive aperture for providing positive electromagnetic coupling between the resonators.

15. The filter of claim 13 wherein the aperture is a negative aperture for providing negative coupling between the resonators.

16. The filter of claim 15 wherein the negative aperture comprises an opening with a conductive coupling mechanism mounted therein.

17. The filter of claim 16 wherein the conductive coupling mechanism is a length of wire.

18. The filter of claim 16 wherein the opening is a first opening, and the negative aperture further comprises a plurality of openings through the conductive plate proximate to the first opening.

19. The filter of claim 1 wherein the housing is placed in a super-cooling fluid.

20. The filter of claim 1 wherein the housing is coupled to a cryogenic refrigerator element.

21. The filter of claim 1 further comprising an adjustable tuning element mounted adjacent the resonator for tuning the filter.
